(19) United States
(12) Patent Application Publication
(10) Pub. No.: US 2006/0013540 A1
(43) Pub. Date: Jan. 19, 2006

(54) Single fiber optical transceiver module

(76) Inventors: Chao Zhang, Chengdu (CN); Xiaobo Tang, Chengdu (CN); Yong Yao, Chengdu (CN)

Correspondence Address: Xin Wen, 3449 Rambow Drive, Palo Alto, CA, 94306, US

(21) Appl. No.: 10/893,803

(22) Filed: Jul. 19, 2004

(51) Int. Cl. G02B 6/36

(52) U.S. Cl. 385/88; 385/92

(57) ABSTRACT

An optical transceiver module includes an electrical interface adapted to receive or output an electrical signal, an optical interface adapted to receive or output an optical signal, and an optical transceiver component. The optical transceiver component includes an Avalanche Photo Diode (APD) that converts an optical signal from the optical interface to an electrical signal; and a laser unit that converts an electrical signal from the electrical interface to an optical signal.

### CROSS-REFERENCES TO RELATED INVENTIONS

The present invention is related to commonly assigned U.S. patent application Ser. No. 10/741,805, filed on Dec. 19, 2003, titled “Bi-directional optical transceiver module having automatic-restoring unlocking mechanism”, commonly assigned U.S. patent application Ser. No. 10/815,326, filed on Apr. 1, 2004, titled “Small form factor pluggable optical transceiver module having automatic-restoring unlocking mechanism and mechanism for locating optical transceiver components”, commonly assigned U.S. patent application Ser. No. 10/850,216, filed on May 20, 2004, titled “Optical Transceiver module having improved printed circuit board”, and commonly assigned Chinese Patent Application No. 200420033019.8 filed on Feb. 27, 2004, titled “High performance single-fiber SFF optical transceiver module”. The disclosures of these related applications are incorporated herein by reference.

### TECHNICAL FIELD

This disclosure relates to electro-optical devices, specifically, optical transceiver modules for telecommunication and data communication applications.

### BACKGROUND

Computers are increasingly being connected to communication lines and other devices or networks with the computers performing as servers to the peripherally connected computers or devices. The data transfer throughput of computer servers can be increased significantly by using fiber optic lines.

Optical signals transmitted through optical fibers are typically converted to electronic signals by an optical transceiver before the optical signals are processed by a computer. Modern optical transceivers have been modularized with standard physical sizes under standard electrical interface agreements and standard optical interface agreements. One such standard agreement is the Small Form Factor (SFF) agreement, and another is the Small Form-factor Pluggable Multi-Source Agreement (SFP MSA).

An optical transceiver module typically includes one or more optical transceiver components, also known as optical sub-assemblies. One type of an optical transceiver component converts optical signals into electrical signals. Another type of optical transceiver component converts electrical signals into optical signals. A third type of optical transceiver component can handle both the optical-to-electrical conversions and the electrical-to-optical conversions. Such an optical transceiver component is sometime referred to as a bi-directional optical transceiver component.

When optical signals are carried on two optical fiber lines, one line for transmission and the other line for reception, two optical transceiver components are needed in each optical transceiver module. When both transmission and reception signals are carried on a single optical line, each optical transceiver module needs a bi-directional optical transceiver component. Such an optical transceiver module is called a single fiber optical transceiver module. If such an optical transceiver also complies with the SFF agreement, it is called a single fiber SFF optical transceiver module. If such an optical transceiver module complies with the SFP agreement, it is called a single fiber SFP optical transceiver module.

A single fiber SFF or SFP optical transceiver module includes a bi-directional optical transceiver component that comprises a photo diode, an optical multiplexer, and a laser unit. The photo diode in the optical transceiver component usually has limited optical signal sensitivity.

### SUMMARY

In one aspect, an optical transceiver module is disclosed, comprising
an electrical interface adapted to receive or output an electrical signal;
an optical interface adapted to receive or output an optical signal; and
an optical transceiver component, comprising:
an Avalanche Photo Diode (APD) that converts an optical signal from the optical interface to an electrical signal; and
a laser unit that converts an electrical signal from the electrical interface to an optical signal.

In another aspect, an optical transceiver module is disclosed, comprising:
an electrical interface adapted to receive or output an electrical signal;
an optical interface adapted to receive or output an optical signal; and
an optical transceiver component, comprising:
   an Avalanche Photo Diode (APD) that converts an optical signal from the optical interface to an electrical signal;
   a laser unit that converts an electrical signal from the electrical interface to an optical signal; and
   an optical multiplexer that receives an optical signal from the optical interface and sends the optical signal to the Avalanche Photo Diode and receives an optical signal from the laser unit and sends the optical signal to the optical interface.

In yet another aspect, an optical transceiver module is disclosed, comprising:
an electrical interface adapted to receive or output an electrical signal;
an optical interface adapted to receive or output an optical signal;
an optical transceiver component, comprising:
   an Avalanche Photo Diode (APD) that converts an optical signal from the optical interface to an electrical current signal;
   a laser unit that converts an electrical signal from the electrical interface to an optical signal; and
a step-up circuit that converts an electrical current signal from the Avalanche Photo Diode to an electrical voltage signal that is sent to the electrical interface.

Embodiments may include one or more of the following advantages. The present invention provides an Avalanche Photo Diode (APD) for optical-to-electrical conversion, which greatly enhances the optical receiving sensitivity. In addition, the present invention provides a step-up circuit in the Printed Circuit Board (PCB) of the optical transceiver module, which extends the functionality of the optical transceiver module.

### DESCRIPTION OF DRAWINGS

FIG. 1 is a perspective view of an optical transceiver module in accordance with the present invention.

FIG. 2 is a partial perspective view of the optical transceiver module under its sheet metal cover.

FIG. 3 is a block diagram of the optical sub-assembly for the optical transceiver module of FIG. 2.

FIG. 4 is a circuit diagram of a step-up circuit.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

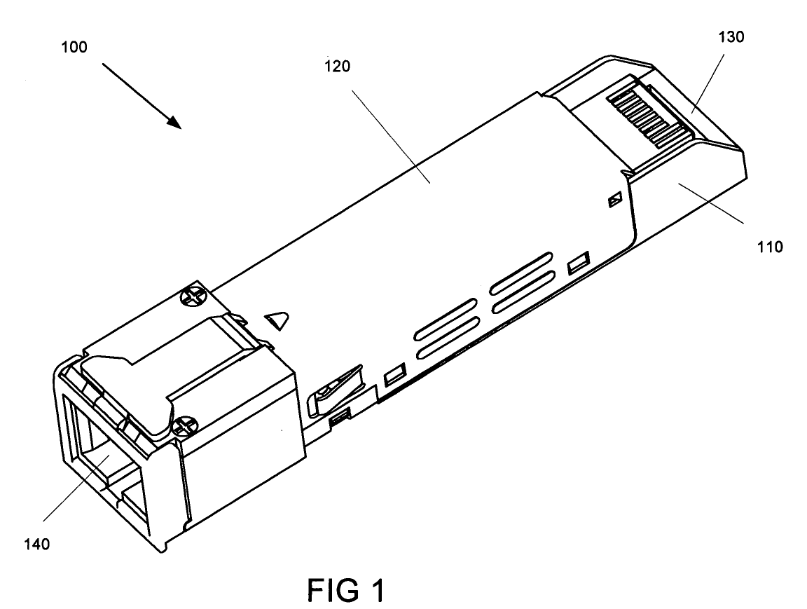

FIG. 1 is a perspective view of a single fiber optical transceiver module 100. The geometry and dimensions of the optical transceiver module 100 in FIG. 1 are in consistence with a single fiber SFP optical transceiver module or a single fiber SFF optical transceiver module. In particular, the optical interface and the electrical interface are the same for an SFF optical transceiver module and an SFP optical transceiver. FIG. 1 therefore illustrates both SFP and SFF optical transceiver modules within the scope of the present invention.

As shown in FIG. 1, the optical transceiver module 100 comprises a case body 110, a sheet metal cover 120, an electrical interface 130, and an optical interface 140.

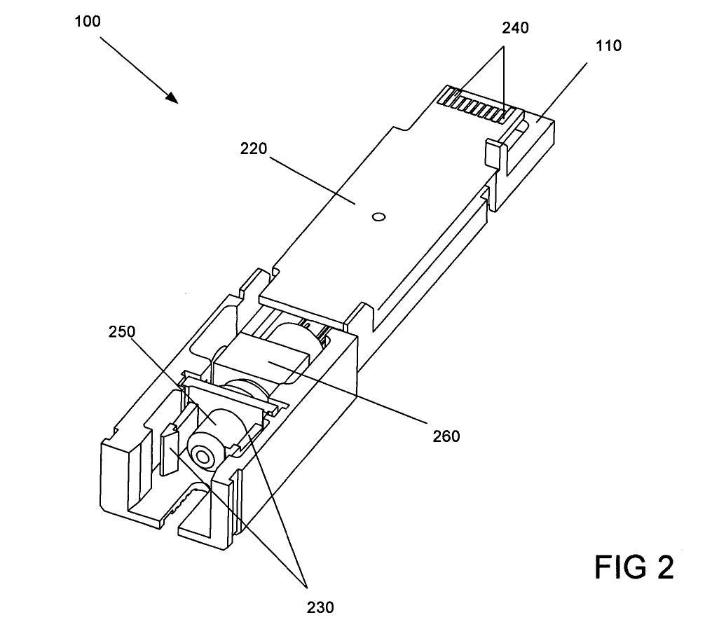

Under the sheet metal cover 120, shown as in FIG. 2, the optical transceiver module 100 further comprises a Printed Circuit Board (PCB) 220 and golden finger pin stripes 240 on the PCB 220, a pair of optical connection supporting racks 230, a bi-directional optical transceiver component 250 and its corresponding optical transceiver component container 260. In FIG. 2, a majority portion of the optical transceiver component 250 is covered by the optical transceiver component container 260.

The end of the optical transceiver component 250 shown in FIG. 2 can be connected to the single optical fiber line to receive and transmit optical signals. The optical connection supporting racks 230 are used to lock the connector of the single optical fiber after a single optical fiber is inserted into optical interface 140. On the opposite end of the optical transceiver component 250 (not shown in FIG. 2) are several connection pins to be connected to the PCB 220.

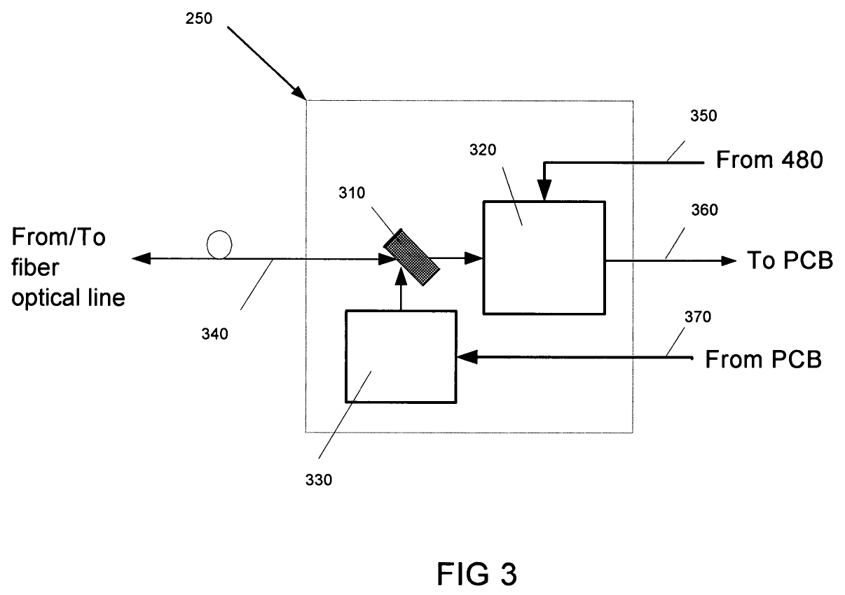

The optical transceiver component 250, shown in FIG. 3, comprises an optical multiplexer 310, an Avalanche Photo Diode (APD) 320, and a laser unit 330.

In the reception direction, the optical multiplexer 310 receives the optical input signals from the bi-directional single fiber optic line 340, and transmits the optical signal to the input of the APD 320. The APD 320 converts the optical signals into electrical current signals at the electrical output 360 and the electrical output 360 is sent to the PCB 220. One the PCB, a special purpose IC chip processes the electrical signal from 360 and sends the processed electrical signal out of the optical transceiver module 100 through its electrical interface 130.

In the transmission direction, when electric signals are to be converted to optical signals and sent out to the single fiber optical line, electrical transmission signals are received at the electrical interface 130 of the optical transceiver module 100. The electrical transmission signals are then processed by a special purpose IC chip on the PCB 220. The processed electrical signal from the IC chip feeds into the laser unit 330 as shown in FIG. 3. The laser unit 330 generates optical signals in response to the input electrical signals. The optical multiplexer 310 receives the optical signals generated by the laser unit 330 and in turn transmits the optical signals to the bi-directional single fiber optical line 340.

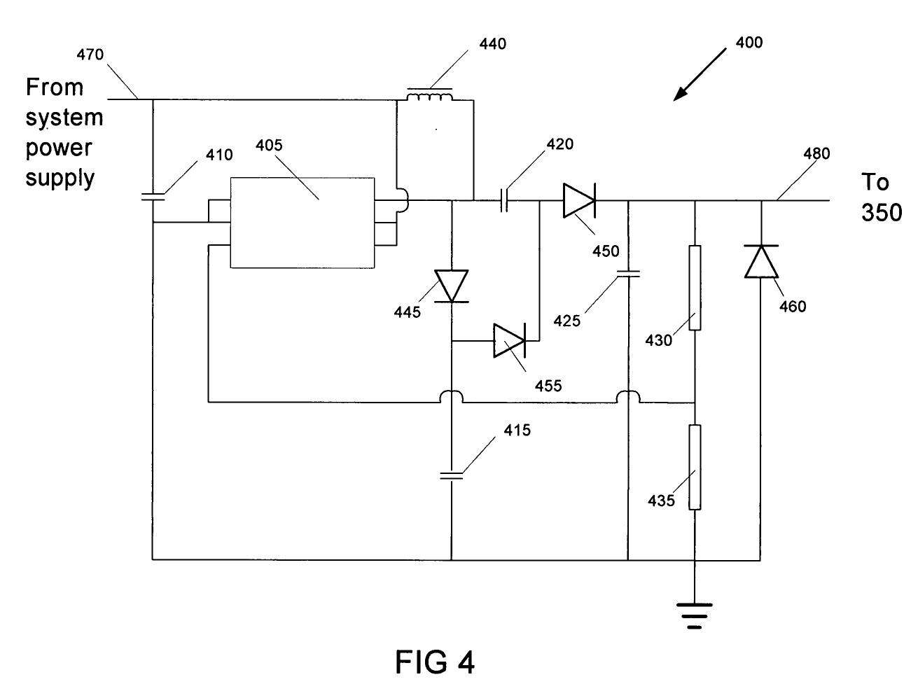

On the reception path, a bias input 350 of the APD 320 is needed to insure the photo diode working properly. The bias voltage is supplied by the step-up circuit 400 shown in FIG. 4. The input point 470 to the step-up circuit 400 comes from the operation power supply of the optical transceiver module 100. The output point 480 of the step-up circuit 400 drives the bias input point 350 of the APD 320. The function of the step-up circuit 400 is to convert the operation power supply (usually around 3 V) to a high voltage power supply (usually around 60 V) at the bias input 350 of the APD 320 as the bias voltage.

FIG. 4 shows a detailed circuit diagram of the step-up circuit. The step-up circuit 400 comprises a direct current voltage converter 405, a plurality of capacitors 410, 415, 420, and 425, a plurality of resistors 430 and 435, an inductor 440, and a plurality of diodes 445, 450, 455 and 460. The step-up circuit 400 receives operation power supply as its input at point 470, and the step-up circuit 400 outputs a high voltage power supply 480 that is connected to the bias input 350 of the APD 320.

The present invention provides several advantages over similar prior art optical transceiver modules. First of all, an Avalanche Photo Diode (APD) is used instead of an ordinary photo diode in the present invention for the optical-to-electrical conversion. The APD greatly enhances the optical receiving sensitivity. Secondly, a step-up circuit is included on the Printed Circuit Board (PCB) of the optical transceiver module of the present invention. The step-up circuit generates a bias input for the APD from within the optical transceiver module, which eliminates a high voltage power supply from outside of the optical transceiver module.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

### PART NUMBERS

100 optical transceiver module
110 body case of optical transceiver module
120 sheet metal cover of optical transceiver module
130 electrical interface
140 optical interface
220 printed Circuit Board
230 optical connection supporting racks
240 golden finger pins
250 optical transceiver component
260 optical transceiver component container
300 optical transceiver component block
310 optical multiplexer
320 Avalanche Photo Diode (APD)
330 laser unit
340 single fiber input/output
350 bias input
360 electric output
370 electrical transmission input
400 step-up circuit
405 direct current voltage converter
410 capacitor
415 capacitor
420 capacitor
425 capacitor
430 resistor
435 resister
440 inductor
445 diode
450 diode
455 diode
460 diode
470 step-up circuit input
480 step-up circuit output

What is claimed is:

1. An optical transceiver module, comprising
an electrical interface adapted to receive or output an electrical signal;
an optical interface adapted to receive or output an optical signal; and
an optical transceiver component, comprising:
an Avalanche Photo Diode (APD) that converts an optical signal from the optical interface to an electrical signal; and
a laser unit that converts an electrical signal from the electrical interface to an optical signal.

2. The optical transceiver module in claim 1, wherein the optical transceiver component further comprises an optical multiplexer that can receive an optical signal from the optical interface and send the optical signal to the Avalanche Photo Diode.

3. The optical transceiver module in claim 2, wherein the optical multiplexer receives an optical signal from a single fiber optical line.

4. The optical transceiver module in claim 2, wherein the optical multiplexer receives an optical signal from the laser unit and sends the optical signal to the optical interface.

5. The optical transceiver module of claim 1, further comprising a printed circuit board that receives electrical signals from the optical transceiver component.

6. The optical transceiver module in claim 5, wherein the electrical signal produced by the Avalanche Photo Diode (APD) is sent to the printed circuit board.

7. The optical transceiver module of claim 1, wherein the optical interface is adapted to be connected with at least one optical fiber line.

8. The optical transceiver module in claim 1, wherein the Avalanche Photo Diode receives a bias voltage.

9. The optical transceiver module of claim 1, further comprising a housing comprising a first end and a second end, wherein the electrical interface is associated with the first end and the optical interface associated with the second end.

10. The optical transceiver module of claim 1, further comprising a step-up circuit that converts the operation power supply to a high voltage power supply to the Avalanche Photo Diode as the bias input.

11. The optical transceiver module of claim 1, wherein the step-up circuit comprises one or more of a current voltage converter, a diode, a capacitor, a resistor, and an inductor.

12. The optical transceiver module in claim 1, wherein the optical interface and electrical interface comply with the Small Form Factor standard.

13. The optical transceiver module in claim 1, wherein the optical interface and electrical interface comply with the Small Form Factor Pluggable standard.

14. An optical transceiver module, comprising
an electrical interface adapted to receive or output an electrical signal;
an optical interface adapted to receive or output an optical signal; and
an optical transceiver component, comprising:
an Avalanche Photo Diode (APD) that converts an optical signal from the optical interface to an electrical signal;
a laser unit that converts an electrical signal from the electrical interface to an optical signal; and
an optical multiplexer that receives an optical signal from the optical interface and sends the optical signal to the Avalanche Photo Diode and receives an optical signal from the laser unit and sends the optical signal to the optical interface.

15. The optical transceiver module in claim 14, wherein the optical multiplexer receives an optical signal from a single fiber optical line.

16. The optical transceiver module of claim 14, further comprising a printed circuit board that receives electrical signals from the optical transceiver component.

17. The optical transceiver module of claim 14, wherein the optical interface is adapted to be connected with at least one optical fiber line.

18. The optical transceiver module of claim 14, further comprising a step-up circuit that converts an electrical current signal from the Avalanche Photo Diode to an electrical voltage signal.

19. The optical transceiver module in claim 14, wherein the optical interface and electrical interface comply with the Small Form Factor standard or the Small Form Factor Pluggable standard.

20. An optical transceiver module, comprising
an electrical interface adapted to receive or output an electrical signal;
an optical interface adapted to receive or output an optical signal;
an optical transceiver component, comprising:
an Avalanche Photo Diode (APD) that converts an optical signal from the optical interface to an electrical current signal; and
a laser unit that converts an electrical signal from the electrical interface to an optical signal; and
a step-up circuit that converts an electrical current signal from the Avalanche Photo Diode to an electrical voltage signal that is sent to the electrical interface.
